(19) United States
(12) Patent Application Publication
(10) Pub. No.: US 2015/0034266 A1
(43) Pub. Date: Feb. 5, 2015

(54) BUILDING AND REPAIR OF HOLLOW COMPONENTS

(71) Applicant: Siemens Energy, Inc., Orlando, FL (US)

(72) Inventors: Gerald J. Bruck, Oviedo, FL (US); Ahmed Kamel, Orlando, FL (US)

(21) Appl. No.: 14/330,226

(22) Filed: Jul. 14, 2014

Related U.S. Application Data
(63) Continuation-in-part of application No. 13/956,635, filed on Aug. 1, 2013.

(51) Int. Cl. B23P 6/00; B22D 19/10; B23K 26/34; B22D 23/06

(52) U.S. Cl. CPC B23P 6/007; B22D 23/06; B22D 19/10; B23K 26/345
USPC 164/69.1; 164/80; 164/76.1; 164/492

(57) ABSTRACT

A method of building or repair of a hollow superalloy component (20, 61) by forming an opening (38, 62) in a wall (28) of the component; filling a cavity (22B, 64) behind the opening with a fugitive support material (34, 52, 54, 68) to support a filler powder (36) across the opening; traversing an energy beam (42) across the filler powder to form a deposit (44) that spans and closes the opening; in which the deposit is fused to the edges (32, 62) of the opening. The filler powder includes at least metal, and may further include flux. The support material may include filler powder, a solid (54), a foam (52) insert, a flux powder (34) and/or other ceramic powder (68). Supporting powder may have a mesh size smaller than that of the filler powder.

This application is a continuation-in-part of U.S. patent application Ser. No. 13/956,635, filed 1 Aug. 2013, attorney docket number 2013P12505US, which is incorporated by reference herein.

### FIELD OF THE INVENTION

This invention relates generally to the fields of metals joining and additive manufacturing and, more particularly, to a process for depositing metal using a laser heat source.

### BACKGROUND OF THE INVENTION

Superalloy materials are among the most difficult materials to weld due to their susceptibility to weld solidification cracking and strain age cracking. The term “superalloy” as used herein means a highly corrosion and oxidation resistant alloy with excellent mechanical strength and resistance to creep at high temperatures. Superalloys typically include high nickel or cobalt content. Examples of superalloys include alloys sold under the trademarks and brand names Hastelloy, Inconel alloys (e.g., IN 738, IN 792, IN 939), Rene alloys (e.g., Rene N5, Rene 80, Rene 142), Haynes alloys, Mar M, CM 247, CM 247 LC, C263, 718, X-750, ECY 768, 282, X45, PWA 1483 and CMSX (e.g. CMSX-4) single crystal alloys.

FIG. 1 is a chart illustrating the relative weldability of various alloys as a function of their aluminum and titanium content. Alloys such as Inconel® 718 which have relatively lower concentrations of these elements, and consequentially relatively lower gamma prime content, are considered relatively weldable. Alloys such as Inconel® 939 which have relatively higher concentrations of these elements are generally not considered to be weldable, or can be welded only with the special procedures discussed above which increase the temperature/ductility of the material and which minimize the heat input of the process. For purposes of discussion herein, the dashed line 19 indicates a border between a zone of weldability below the line 19 and a zone of non-weldability above the line 19. The line 19 intersects 3 wt. % aluminum on the vertical axis and 6 wt. % titanium on the horizontal axis. Within the zone of non-weldability, the alloys with the highest aluminum content are generally found to be the most difficult to weld. The present inventors have developed techniques for successfully welding such materials, as described in United States patent application publication numbers US 2013/0136868 A1 and US 2013/0140278 A1, for example, both incorporated by reference herein.

Gas turbine airfoils, both rotating blades and stationary vanes, are often fabricated by casting a superalloy material around a fugitive ceramic core that is then removed to form cooling chambers and channels in the blade. It is best to fixture the core at both the root end and the tip end for exact positioning and stability of the core during casting. However, such fixturing prevents casting of a closed blade tip in the primary casting process. A tip cap must be built or completed by a secondary process to close the opening left by the ceramic core. Similarly, the repair of a service damaged blade tip may typically include grinding or cutting off an existing tip and welding a replacement tip cap in place over the hollow blade structure. The repair of other superalloy components may require the closing of an opening in a hollow component.

### BRIEF DESCRIPTION OF DRAWINGS

The invention is explained in the following description in view of the drawings that show:

FIG. 1 is a chart illustrating relative weldability of various superalloys.

FIG. 2 is a top view of a turbine blade tip without a cap.

FIG. 3 is a partial sectional view of a turbine blade tip portion taken along line 3-3 of FIG. 2 enclosed in a cap-building enclosure.

FIG. 4 shows a laser beam traversing a filler powder, forming a metal deposit with a blanket of protective slag.

FIG. 5 shows a tip portion of a turbine blade after forming a cap thereon.

FIG. 6 shows the tip portion of the blade after machining the cap as needed.

FIG. 7 shows a squealer ridge formed around the periphery of the cap.

FIG. 8 shows an insert placed in a cavity as part of the filler support.

FIG. 9 shows a ceramic core extending beyond the blade tip after casting.

FIG. 10 shows a blade tip in an enclosure for building the blade cap using the ceramic core for filler support.

FIG. 11 shows the ceramic core machined below the blade tip surface, leaving space for a filler-supporting powder.

FIG. 12 shows a laser rastering pattern.

FIG. 13 is a top view of a blade tip 20 with a filler powder and flux blanket 40 thereon as described above.

FIG. 14 shows a beam scanning pattern with overlapping sets of concentric tracks.

FIG. 15 is a sectional view of a component with a repair opening being closed by an embodiment of the process herein.

FIG. 16 is a sectional view of a component with a repair opening being closed by another embodiment of the process herein.

FIG. 17 illustrates aspects of a method of the invention.

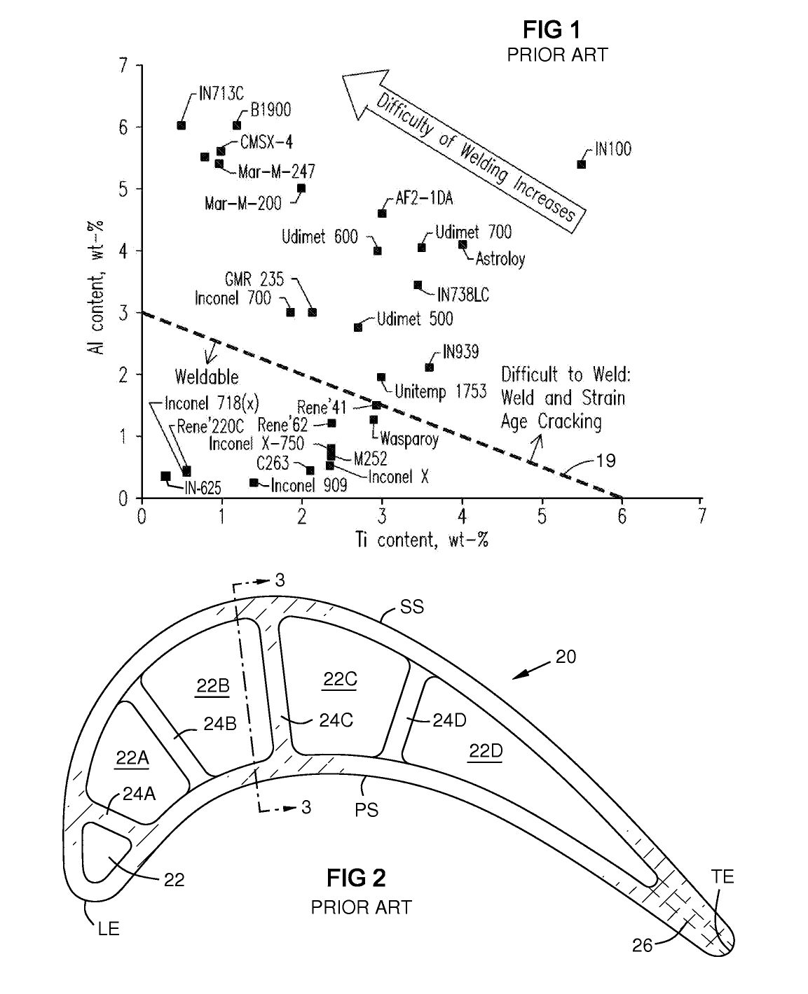

### DETAILED DESCRIPTION OF THE INVENTION

The present inventors have created a process of building a tip cap on a hollow superalloy turbine blade or closing another opening in a component by supporting a filler material across the opening on a supporting element in a cavity of the component, and then traversing the filler material with an energy beam to melt it, forming a deposit across the opening fused to the edges of the opening. The filler material may be a powder that includes metal and may further include flux. It is supported across the opening by a fugitive supporting element behind the opening. “Fugitive” means removable after melting and cooling of the metal, for example by a mechanical process, by fluid flushing, by chemical leaching and/or by any other known process capable of removing the fugitive material from its position. The supporting element may be a powder and/or other form of material disposed in a cavity behind the opening. Examples include additional filler powder and/or flux or ceramic powder. Alternately, the supporting element may be a solid fugitive insert placed in the cavity to support an intermediate supporting powder or to support the filler powder directly. Still alternately, the supporting element may be a spray foam that expands to fill the cavity but which may be fugitively removed using a solvent. Still alternately, the supporting element may be a flexible bladder that can be pneumatically or hydraulically pressurized to fill the cavity and subsequently deflated for removal.

An energy beam, for example a laser, traverses the filler powder across the opening, melting it to a desired depth, such as the thickness of the tip cap or the thickness of a wall being repaired. Upon cooling, this forms a solid metal deposit across the opening. The supporting element shields the backside of the deposit from air. In one embodiment, the supporting element is a powder that includes or is formed completely of shielding flux. For external shielding, a layer of powdered flux may be disposed over the filler material or flux may be mixed with the powdered metal to create a slag layer during heating that protects the deposit from the atmosphere. Alternatively, the process may be conducted in a chamber and an inert gas may be introduced or a vacuum may be provided.

FIG. 2 is a top view of a turbine blade tip 20 without a cap, as may be formed in a prior art casting process where ceramic core elements extend through a casting mold to define the shape of hollow cooling channels 22, 22A-D. This condition occurs on a newly cast blade prior to building a tip cap thereon and on a used blade after removal of a degraded tip cap for replacement. The blade has a leading edge LE; trailing edge TE; pressure and suction sides PS, SS. It may have a leading edge cooling channel 22 and serpentine cooling channels 22A-D separated by internal partitions 24A-D, some of which (24A, 24C) may extend to the tip cap, others of which (24B, 24D) may not. It may further include trailing edge exit passages 26. While embodiments of the invention are described in relation to a turbine blade, the invention is not so limited and may encompass other components.

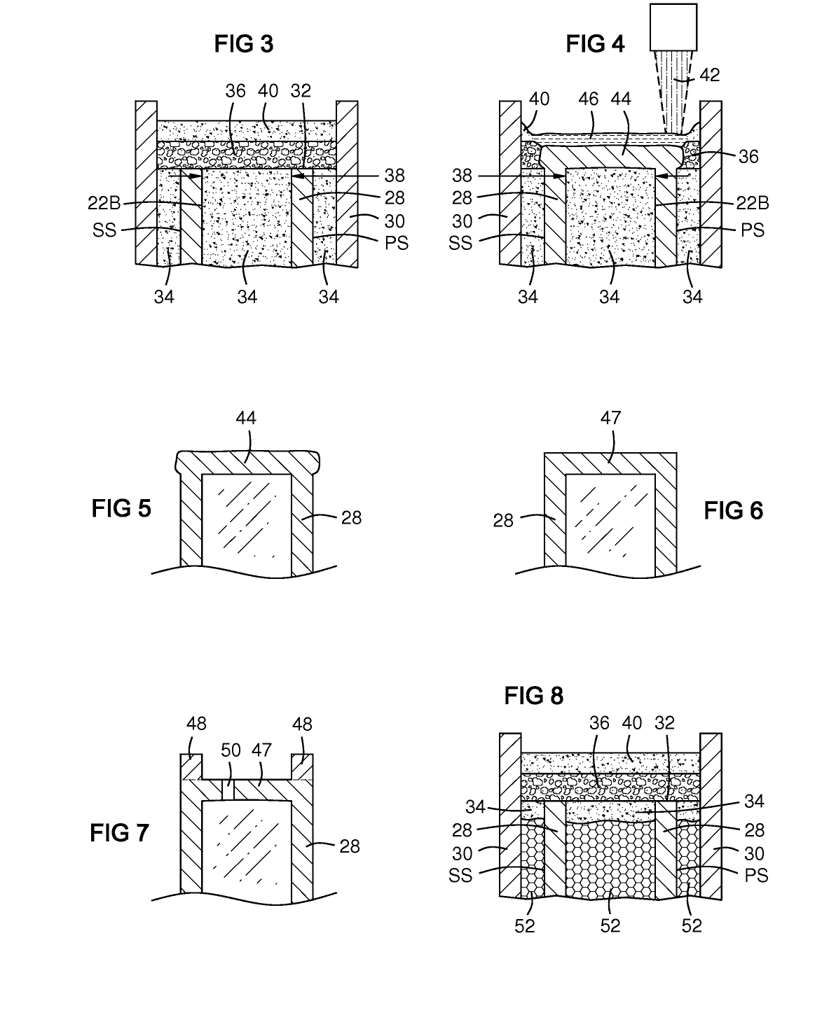

FIG. 3 is a partial sectional view of outer walls 28 of a turbine blade tip taken along line 3-3 of FIG. 2 and enclosed in a cap-building enclosure 30. The blade may be newly cast after removal of the fugitive casting core and machining of the tip surface 32. Alternately it may be a used blade after removal of an old tip cap for replacement. The cooling channels are filled with a supporting powder 34, and the blade may be surrounded by the supporting powder in the enclosure up to the level of the tip surface 32. In one embodiment, the supporting powder may include or be a welding flux material. A layer of filler material 36 including a metal powder covers the blade tip surface 32 and spans the opening 38 at the blade tip. A layer of flux 40 may cover the filler powder 36 to create a shielding slag layer that thermally insulates the molten metal deposit and shields it from air.

The metal powder may have a composition similar to, or the same as, the metal composition of the component walls 28. Optionally the filler material may be a granulated metal powder mixed with granulated flux, or composite metal/flux particles. Flux materials may include for example alumina, carbonates, fluorides and silicates. With respect to some turbine components, the walls 28 may be composed of a superalloy, and the filler material may contain a similar superalloy composition in granulated powder form.

FIG. 4 shows a laser beam 42 traversing the filler material 36 across the opening 38, and forming a metal deposit 44 across the opening covered with a blanket of protective slag 46. FIG. 5 shows the tip portion of the blade after removal from the enclosure 30 and removal of the supporting filler powder 34, such as by draining it through an opening in an opposed end of the component. The metal deposit 44 is fused to the walls 28 of the blade, and spans across the opening. FIG. 6 shows the tip portion of the blade after machining of the deposit to finish the surfaces and edges of the blade cap 47 as needed.

Alternately or additionally to providing an over-layer of flux 40, the heating process may be performed in a chamber. A vacuum may be created in the chamber to protect the deposit 44 from air. Alternatively, an inert gas may be introduced into the chamber and/or into the cavity 22B to protect the deposit from air.

The supporting filler powder 34 may include a ceramic, for example zirconia, and/or may include a flux material, for example alumina, carbonates, fluorides and silicates. If the supporting powder 34 has a smaller mesh size than the filler powder 36, for example less than half the average particle size, the line of demarcation between the two powders will be sharper and molten metal will have less of a tendency to flow into the supporting powder, thereby producing a smoother interior surface on the deposit 44. The supporting powder 34 may be ground to a desired smaller mesh size range before use.

FIG. 7 shows a radially extending ridge called a squealer tip 48 formed around the periphery of the cap 47. The squealer tip may be formed by any known process, or it may be formed in the enclosure 30 by adding and melting a further layer(s) of alloy powder 36 and controlling the laser 42 to melt the powder in a pattern to form the squealer tip 48. The squealer tip may be formed of the same or a different material than the tip cap 46. For example, the squealer tip may be made of a more ductile alloy, such as IN-625. Following creation of the squealer tip, the blade tip may be machine finished. Coolant exit holes 50 may be drilled in the blade cap 46 and/or the blade outer walls 28. Alternatively, holes 50 may be formed during the melting step of FIG. 4 by appropriate control of the laser 42. Some or all of the machining of FIG. 6 may be deferred until after the squealer tip is added.

FIG. 8 shows an insert 52 placed in the cavity of the blade as part of the supporting element to partly fill the cavity, reducing the amount of supporting powder 34 needed. It may be formed as a solid and placed in the cavity, or it may be formed in, or packed into, the cavity, for example as a foam or as ceramic fibers or as a bladder.

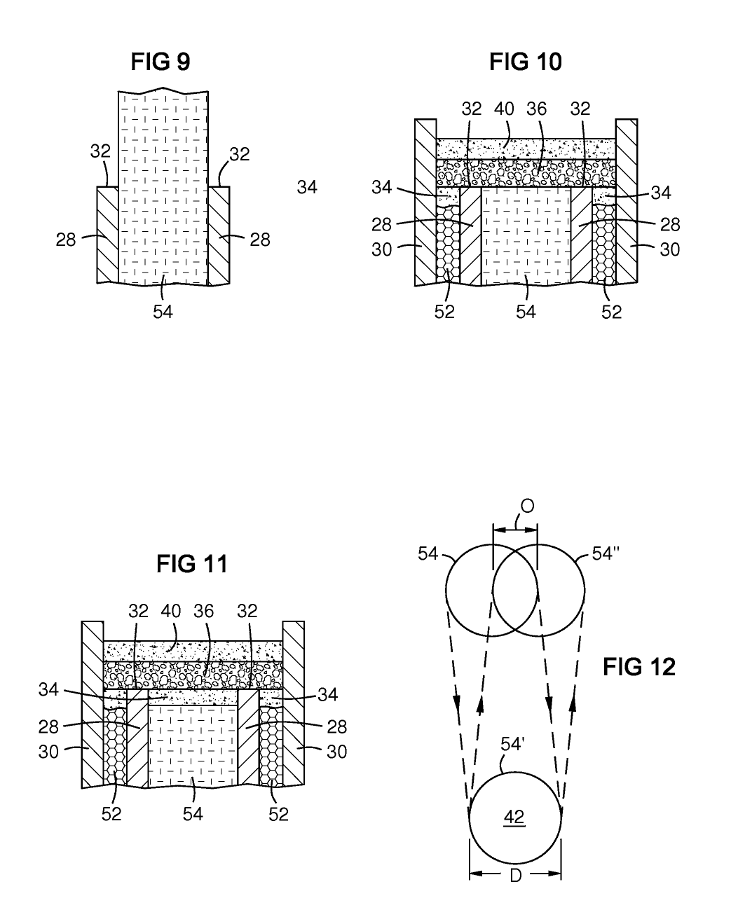

FIG. 9 shows a ceramic core 54 for casting remaining in the blade and extending beyond the blade tip after casting. This core may provide the support element for the filler powder by machining it flush with or below the blade tip surface 32. FIG. 10 shows the resulting blade tip in an enclosure 30 for building the blade cap as previously described. The core 54 may then be removed by chemical leaching. FIG. 11 shows the ceramic core 54 machined below the blade tip surface 32, leaving space for supporting powder.

FIG. 12 illustrates a laser rastering pattern in which a beam 42 with diameter D is moved from a first position 54 to a second position 54′ and then to a third position 54″ and so on. An overlap O of the beam with previous corresponding positions in the pattern is preferably between 25-90% of D to provide optimal heating and melting of the materials. Alternatively, two energy beams may be rastered concurrently to achieve a desired energy distribution across a surface area, with the overlap between the beam patterns being in the range of 25-90% of the diameters of the respective beams.

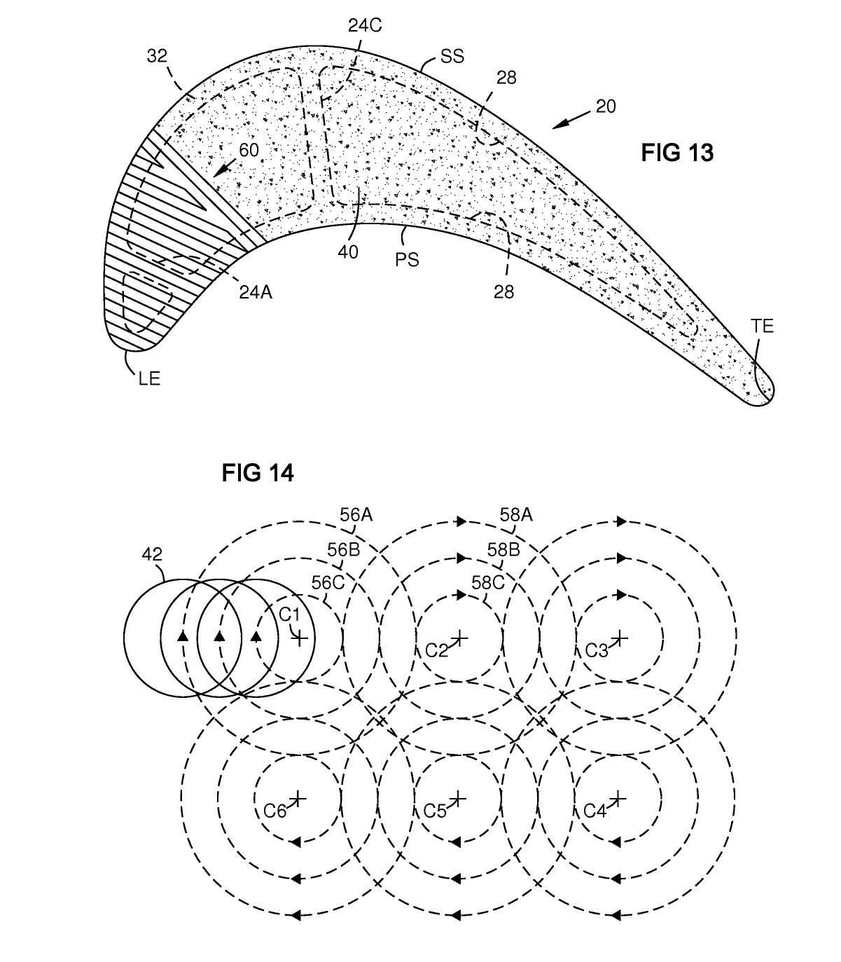

FIG. 13 is a top view of a blade tip 20 with a filler powder and flux blanket 40 thereon as described above. Laser scanning is in progress, as indicated by exemplary scan lines 60. The previously shown enclosure and powder surrounding the blade tip is omitted here for clarity. The laser energy per unit area (intensity) may be varied over the scan area by varying the emitter power, and/or beam dwell time, and/or repetition, and/or overlap percentage to melt the deposit to a desired depth and fuse it to the blade tip walls 28 and to any partitions 24A, 24C that extend to the top surface 32 of the blade tip. Energy intensity may be increased over the top surfaces 32 of the walls and partitions relative to a lower intensity over the blade cavities in order to fuse the filler deposit to the top surface.

FIG. 14 shows a beam scanning pattern in which an energy beam follows a first set of concentric tracks 56A, 56B, 56C about a first center C1, then follows a second set of concentric tracks 58A-C about a second center C2, and may continue to follow additional sets of concentric tracks about successive centers C3-C6. Each set of concentric tracks may contain at least 2 concentric tracks, or at least 3, and overlaps with an adjacent set or sets of concentric tracks. For example, the overlap may be about ⅓ of the diameter of the largest track of each set. This pattern provides controllable multi-pass dwell time in a limited area without hot spots on the surface, allowing a desired uniform melt depth to be achieved. It reduces the need for perfecting a parallel line raster pattern 60 as in FIG. 13 to maintain a long transverse melt front on the metal deposit. A raster pattern 60 or another scan pattern may be used with or without enhancement by the concentric track sets of FIG. 14.

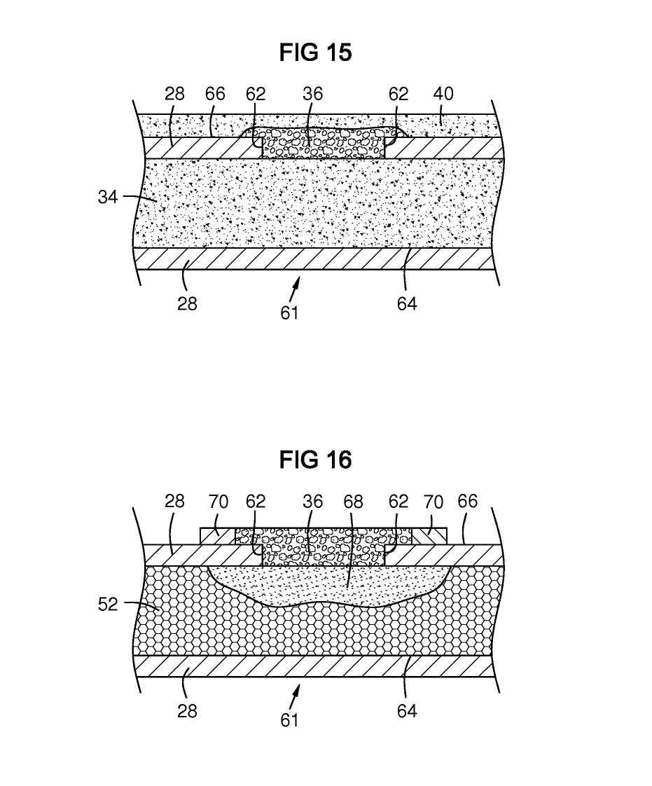

FIG. 15 is a sectional view of a component 61 with an opening 62 having been made in a wall 28 to remove a degraded portion of the wall. A cavity 64 of the component is filled with a supporting element such as a supporting powder 34 or insert as previously described. A filler powder 36 overfills the opening to allow for reduction during melting to a final deposition level flush with or higher than the opening. Machining may be used to finish the outer surface after removal of the slag blanket as previously described.

FIG. 16 is a sectional view of a component 61 with an opening 62 having been made in a wall 28 to remove a degraded portion of the wall. A cavity 64 of the component is filled with a supporting element such as a foam insert 52 with a space or depression under the opening 62 containing supporting powder such as a ceramic powder 68. A filler powder 36 including metal powder and flux powder overfills the opening to allow for reduction during melting to a final deposition level flush with or higher than the opening. It may be bounded by a containment ring or frame 70 surrounding the opening. The ceramic powder may have a smaller mesh size than the filler powder 36, for example less than half the mesh size of the filler powder, to reduce drainage of metal power into the supporting powder and to reduce soaking of the molten metal into the supporting powder. Machining may be used to finish the outer surface after removal of the slag blanket as previously described.

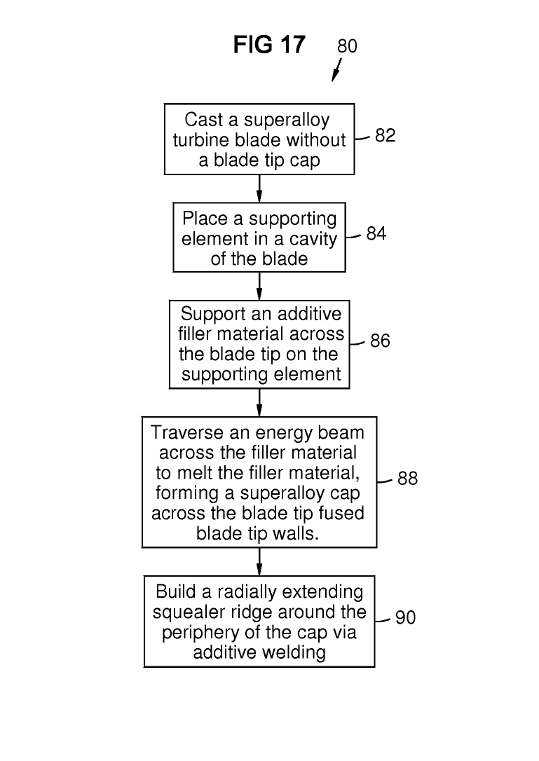

FIG. 17 illustrates aspects of a method 80 of an embodiment the invention, including the steps of:

82—Casting a superalloy turbine blade without a blade tip cap;

84—Placing a supporting element in a cavity of the blade;

86—Supporting an additive filler material across the blade tip on the supporting element.

88—Traversing an energy beam across the filler material to melt the filler material, forming a superalloy cap across the blade tip fused to the blade tip walls; and

90—Building a radially extending squealer ridge around the periphery of the cap via additive welding.

The energy beam 42 used in the process herein may be a laser beam or other known type of energy beams, such as an electron beam, plasma beam, multiple laser beams, etc. A beam with a broad area can be produced by a diode laser to reduce intensity, reducing the thermal gradient and cracking effects.

Inclusion of flux in the filler powder 36 and/or in a flux over-layer 40, produces a slag layer 46 that shields the molten material and the solidified hot repair deposit material 44 from the atmosphere. The slag floats to the surface, separating the molten or hot metal from the atmosphere, thus avoiding or minimizing the use of expensive inert gas. The slag also acts as a thermal blanket that allows the solidified material to cool slowly and evenly, reducing residual stresses that can contribute to post weld reheat or strain age cracking. Flux in the filler powder provides a cleansing effect that removes trace impurities such as sulfur and phosphorous that contribute to weld solidification cracking. Such cleansing includes deoxidation of the metal powder. Since the flux powder is in intimate contact with the metal powder, it is especially effective in accomplishing this function. A flux over-layer can provide energy absorption and trapping to more effectively convert the laser beam into heat energy, thus facilitating a precise control of heat input, and a resultant control of material temperature during the process. The flux may be formulated to compensate for loss of volatized elements during processing or to actively contribute additive elements to the deposit that are not otherwise provided by the metal powder.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method comprising:
disposing a supporting element in a cavity of a component below an opening in a wall of the component;
supporting a filler material comprising a metal powder on the supporting element across the opening;
applying heat to the filler material to melt it across the opening;
allowing the melted filler material to solidify to form a metal deposit across the opening; and,
removing the supporting element and any unconsumed filler material.

2. The method of claim 1, further comprising disposing the supporting element in a cavity of a superalloy gas turbine blade wherein the opening is at a tip of the blade, and wherein the metal deposit forms a blade tip cap.

3. The method of claim 2, further comprising forming a radially extending squealer ridge around a periphery of the tip cap by additive welding.

4. The method of claim 1, further comprising removing a distressed portion of the wall to form the opening across which the deposit forms a repair.

5. The method of claim 1, wherein the wall is made of a superalloy material, and the filler material comprises constituents of the superalloy and a flux material.

6. The method of claim 1, wherein the wall is made of a superalloy material, the metal powder comprises a first subset of constituents of the superalloy material, and the filler material further comprises a flux powder comprising a second subset of constituents of the superalloy material.

7. The method of claim 1, further comprising, applying the heat by traversing a laser beam across the filler material, and controlling the laser beam to melt the filler material to a depth corresponding to a thickness of the wall.

8. The method of claim 1, further comprising applying the heat by rastering a laser beam over the filler material, increasing an intensity of the beam as it passes over edges of the wall sufficiently to fuse the deposit thereto, and decreasing the intensity of the beam as it passes over the cavity relative to the intensity over the edges of the wall.

9. The method of claim 1, further comprising covering the filler material with a flux layer before applying the heat; and removing a slag layer from the deposit after solidification of the deposit.

10. The method of claim 1, further comprising supporting the filler material across the opening by at least partially filling the cavity with a flux powder forming the supporting element.

11. The method of claim 1, further comprising supporting the filler material across the opening by at least partially filling the cavity with a ceramic powder forming the supporting element.

12. The method of claim 1, further comprising supporting the filler material across the opening by at least partially filling the cavity with a fugitive material forming the supporting element, and removing the fugitive material after solidification of the deposit.

13. The method of claim 1, further comprising:
disposing a fugitive material in the cavity such that a depression exists between the fugitive material and the opening;
filling the depression with a supporting powder, the fugitive material and the supporting powder forming the supporting element;
supporting the filler material across the opening on the supporting powder; and
removing the fugitive material and the supporting powder after solidification of the deposit.

14. The method of claim 1, further comprising applying the heat by traversing an energy beam in a series of overlapping sets of concentric tracks across the opening.

15. The method of claim 1, wherein the energy beam is a laser beam, and further comprising traversing the laser beam in a plurality of sets of concentric circular tracks, each set comprising at least 3 concentric circular tracks, and each set overlapping an adjacent set by at least ⅓ of a diameter of a largest of the circular tracks of the respective overlapping sets.

16. The method of claim 1, wherein the supporting element is formed as a powder having a mesh size less than half of a mesh size of the metal powder.

17. A method comprising:
disposing a powder support material under an opening in a wall of a component;
spanning the opening with a filler powder supported by the powder support material, the powder support material comprising a smaller mesh size than the filler powder;
traversing an energy beam across the filler powder to melt it across the opening and fuse it to edges of the wall opening; and
allowing the melted filler powder to solidify to form a deposit across the opening, wherein the deposit is fused to the wall.

18. The method of claim 17, further comprising traversing the energy beam in a series of overlapping sets of concentric tracks.

19. The method of claim 17, wherein the component is a superalloy gas turbine blade and the opening is part of a cooling channel cavity formed therein, further comprising:
disposing a powder flux material in the cavity under the opening;
spanning the opening with a superalloy powder supported by the flux material;
covering the superalloy powder with a layer of flux powder;
traversing a laser beam across the opening to form a deposit of superalloy material covered by a layer of slag across the opening; and
removing the flux material from the cavity and removing the slag.

20. A method comprising:
removing material from a damaged gas turbine component to reveal an opening through a wall of the component into a cooling channel cavity;
disposing a support material in the cooling channel cavity under the opening;
covering the opening with an alloy powder supported by the support material;
traversing a laser beam across the alloy powder to melt it across the opening and fuse it to edges of the wall opening;
allowing the melted filler powder to solidify to form a seal across the opening; and
removing the support material from the cooling channel cavity.
